(19) United States
(12) Patent Application Publication
(10) Pub. No.: US 2023/0024229 A1
(43) Pub. Date: Jan. 26, 2023

(54) GROUND POWER SUPPLY APPARATUS

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Shuntaro OKAZAKI, Sunto-gun (JP); Shogo TSUGE, Fuji-shi (JP); Kazuhisa MATSUDA, Sunto-gun (JP)

(21) Appl. No.: 17/869,728

(22) Filed: Jul. 20, 2022

(30) Foreign Application Priority Data
Jul. 21, 2021 (JP) 2021-120926

(51) Int. Cl. H02J 50/80; H02J 50/40; H02J 50/12; B60L 53/12

(52) U.S. Cl. CPC H02J 50/80; H02J 50/40; H02J 50/12; B60L 53/12

(57) ABSTRACT

A ground power supply apparatus for transmitting power to a vehicle by noncontact has: a plurality of power transmission apparatuses for transmitting power to the vehicle; at least one detection device for detecting a signal emitted from the vehicle using narrow range wireless communication; and a controller for controlling the power transmission apparatuses. The power transmission apparatuses are arranged in a road aligned in a direction of advance of the vehicle. One first detection device is arranged so as to enable detection of the signal at an upstream side from the most upstream power transmission apparatus. The control device controls transmission of power from power transmission apparatuses other than the first power transmission apparatus positioned the most upstream, based on the signal detected by the first detection device and power transmission result information at the power transmission apparatus positioned upstream of that power transmission apparatus.

### FIELD

The present disclosure relates to a ground power supply apparatus.

### BACKGROUND

Noncontact power supply systems using transmission methods such as magnetic field coupling (electromagnetic induction), electric field coupling, magnetic field resonance coupling (magnetic field resonance), and electric field resonance coupling (electric field resonance) and other such transmission methods to transfer power from a ground power supplying apparatus provided on a ground surface to a running vehicle by noncontact have been studied. In order to transfer power from a ground power supplying apparatus to a vehicle by noncontact in this way, it is necessary to transmit information relating to the vehicle from the vehicle to the ground power supplying apparatus, and control the ground power supplying apparatus based on this information. As such a noncontact power supply system, a noncontact power supply system transferring power from a ground power supplying apparatus to a running vehicle by noncontact, if a power supply request is wirelessly sent from the vehicle while the vehicle is running has been studied (for example, JP2018-157686A).

### SUMMARY

In this regard, if a ground power supply apparatus has a plurality of power transmission apparatuses for transmitting power to a vehicle, it is necessary to control the power transmission apparatuses based on information transmitted from the vehicle.

In consideration of the above problem, an object of the present disclosure is to control the power transmission apparatuses for a ground power supply apparatus having a plurality of power transmission apparatuses, based on information transmitted from a vehicle.

The gist of the present disclosure is as follows.

(1) A ground power supply apparatus for transmitting power to a vehicle by noncontact, comprising:
a plurality of power transmission apparatuses for transmitting power to the vehicle;
at least one detection device for detecting a signal including information on the vehicle relating to power transfer, including vehicle identification information, emitted from the vehicle using narrow range wireless communication; and
a control device for controlling the power transmission apparatuses, wherein
the power transmission apparatuses are arranged in a road aligned in a direction of advance of the vehicle,
one first detection device among the detection devices is arranged so as to enable detection of the signal at an upstream side from the most upstream power transmission apparatus in the direction of advance of the vehicle, and
the control device controls transmission of power from power transmission apparatuses other than the first power transmission apparatus positioned the most upstream in the direction of advance of the vehicle, based on the signal detected by the first detection device and power transmission result information at the power transmission apparatus positioned at the upstream side from that power transmission apparatus.

(2) The ground power supply apparatus according to above (1), wherein
the ground power supply apparatus has a plurality of ground units respectively comprising the power transmission apparatus, the detection device, and the control device,
the control devices of the different ground units are connected to be able to communicate with each other, and
the power transmission apparatus of each ground unit is controlled by the control device of that ground unit.

(3) The ground power supply apparatus according to above (1), wherein
the ground power supply apparatus has a plurality of ground units respectively comprising the power transmission apparatus and the detection device, and
the control device is connected to the power transmission apparatuses and the detection devices of the plurality of ground units and controls the plurality of power transmission apparatuses connected to that control device.

(4) The ground power supply apparatus according to above (2) or (3), wherein the detection device of each ground unit is arranged so as to enable detection of the signal from the vehicle when the vehicle is positioned at an upstream side from the power transmission apparatuses of that ground unit in the direction of advance of the vehicle.

(5) The ground power supply apparatus according to any one of above (2) to (4), wherein the control device for controlling a power transmission apparatus of the ground unit provided at a second place or following places from the upstream side in the direction of advance of the vehicle controls the power transmission apparatus of that ground unit, based on the information included in the signal detected by the detection device of that ground unit, regardless of the information contained in the signal detected by the first detection device and power transmission result information in the power transmission apparatus of the ground unit positioned at the upstream side from that ground unit, when the detection device of that ground unit detects the signal including the information.

(6) The ground power supply apparatus according to any one of above (2) to (5), wherein the control device for controlling the power transmission apparatus of the ground unit provided at a third place or following places from the upstream side in the direction of advance of the vehicle controls the power transmission apparatus of that ground unit, based on the information included in a signal detected by the signal detection device of an intermediate ground unit downstream from a most upstream ground unit having the first detection device and upstream from that ground unit and power transmission result information in the detection device of the ground unit downstream from the intermediate ground unit and upstream from that ground unit, when the detection device of that ground unit does not detect a signal from the vehicle and the detection device of the intermediate ground unit detects a signal including the information.

(7) The ground power supply apparatus according to any one of above (3) to (6), wherein the control device controlling the power transmission apparatus of each ground unit does not allow power transmission from the power transmission apparatus of that ground unit to the vehicle, when the detection device of that ground unit and the detection device of the ground unit arranged at an upstream side from that ground unit do not receive the information.

According to the present disclosure, it is possible to control the power transmission apparatuses for a ground power supply apparatus having a plurality of power transmission apparatuses, based on information transmitted from a vehicle.

### BRIEF DESCRIPTION OF DRAWINGS

FIG. 1 is a view schematically showing the configuration of a noncontact power supply system.

FIG. 2 is a view schematically showing a ground power supply apparatus provided at a road.

FIG. 3 is a schematic view of the configuration of a controller and equipment connected to the controller.

FIG. 4 is a schematic view of the configuration of an ECU and equipment connected to the ECU.

FIGS. 5A to 5D are views schematically showing a way of transmission of information in a ground power supply apparatus having a plurality of ground units.

FIGS. 6A to 6D are views, similar to FIGS. 5A to 5D, schematically showing a way of transmission of information in a ground power supply apparatus having a plurality of ground units.

FIG. 7 is a flow chart showing a flow of control processing of a ground unit by a controller of a ground unit positioned at an upstream most of a ground power supply apparatus.

FIG. 8 is a flow chart showing a flow of control processing of a ground unit by a controller of a ground unit at a downstream side from a ground unit positioned at an upstream most of a ground power supply apparatus.

FIG. 9 is a view, similar to FIG. 2, schematically showing a ground power supply apparatus provided at a road.

### DESCRIPTION OF EMBODIMENTS

Below, referring to the drawings, embodiments will be explained in detail. Note that, in the following explanation, similar elements will be assigned the same reference notations.

Overall Configuration of Noncontact Power Supply System 1

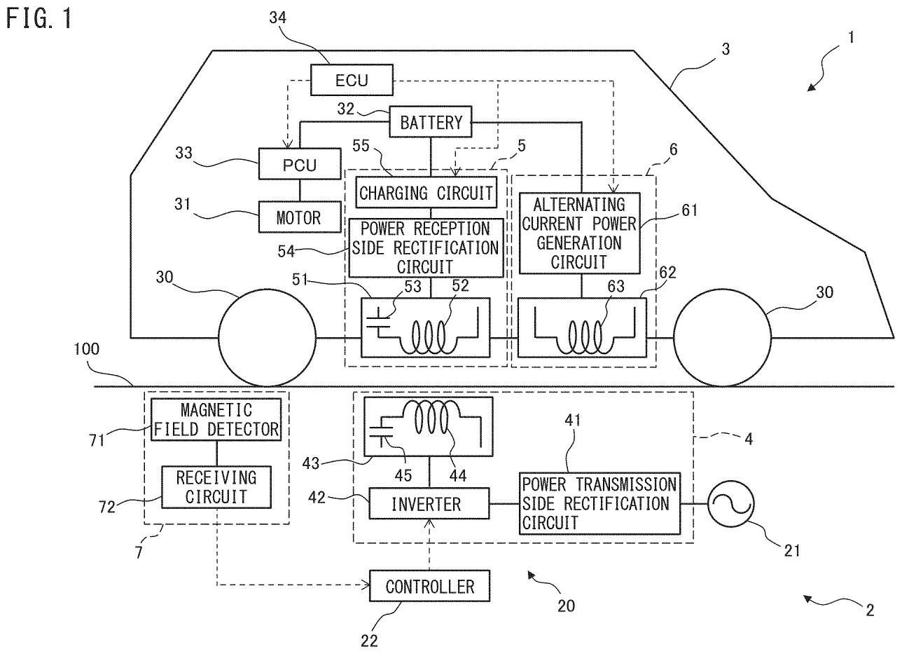

FIG. 1 is a view schematically showing the configuration of a noncontact power supply system 1. The noncontact power supply system 1 has a ground power supply apparatus 2 and a vehicle 3 running on a road 100, and transfers power by noncontact from the ground power supply apparatus 2 to the vehicle 3 by magnetic field resonance coupling (magnetic field resonance). In particular, in the present embodiment, the noncontact power supply system 1 transfers power by noncontact from the ground power supply apparatus 2 to the vehicle 3 while the vehicle 3 is running. Therefore, the ground power supply apparatus 2 transmits power by noncontact to the vehicle 3 while the vehicle 3 is running, and the vehicle 3 receives power by noncontact from the ground power supply apparatus 2 while the vehicle 3 is running. The ground power supply apparatus 2 has power transmission apparatuses 4 configured so as to transmit power to the vehicle 3 by noncontact, while the vehicle 3 has a power reception apparatus 5 configured to receive power from the power transmission apparatuses 4 by noncontact. As shown in FIG. 1, the power transmission apparatuses 4 are buried in a road 100 (in the ground) on which the vehicle 3 is running, for example, at the center of lane on which the vehicle 3 is running.

Note that, the term “while running” means the state where a vehicle 3 is positioned on a road for running. Therefore, the term “while running” includes not only the state where a vehicle 3 is actually running at any speed larger than zero, but also, for example, the state where it is stopped on a road due to waiting for a traffic light to change. On the other hand, a case where a vehicle 3 is positioned on the road, but for example is being parked, is not included in “while running”.

Configuration of Ground Power Supply Apparatus

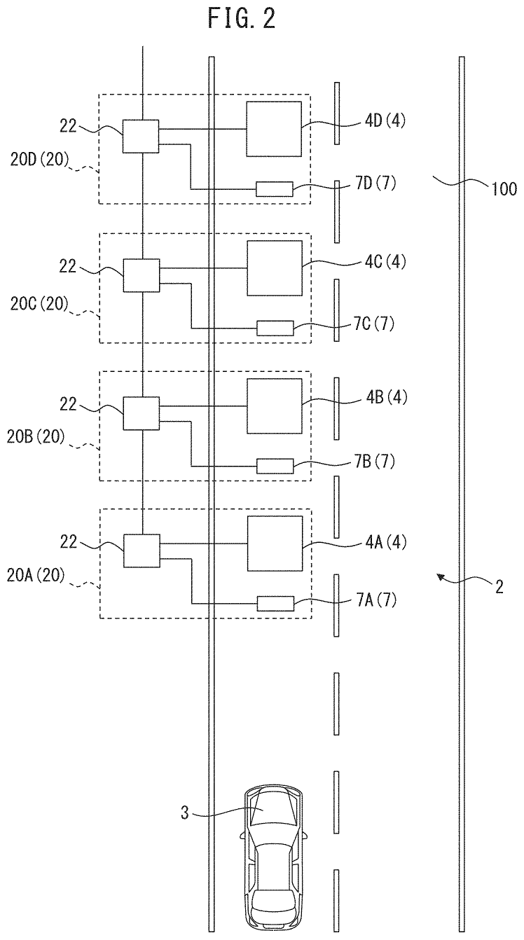

FIG. 2 is a view schematically showing a ground power supply apparatus 2 provided at a road. In FIG. 2, the ground power supply apparatus 2 is shown in a state exposed on the road 100, but in actuality, the components of the ground power supply apparatus 2 (such as power transmission apparatuses 4) are buried in the road 100. As shown in FIGS. 1 and 2, the ground power supply apparatus 2 has a plurality of ground units 20. As shown in FIG. 1, each ground unit 20 is provided with a power transmission apparatus 4, power source 21, and controller 22. The power source 21 and the controller 22 may be buried inside the road 100 and may be arranged at locations (including ground) separate from the inside of the road 100.

The power source 21 supplies power to the power transmission apparatus 4. The power source 21, for example, is a commercial alternating current power supply for supplying single-phase alternating current power. Note that, the power source 21 may be an alternating current power supply for supplying three-phase alternating current power, or may be a direct current power supply such as a fuel cell.

The power transmission apparatus 4 sends the power supplied from the power source 21 to the vehicle 3. The power transmission apparatus 4 has a power transmission side rectification circuit 41, inverter 42, and power transmission side resonance circuit 43. In the power transmission apparatus 4, the alternating current power supplied from the power source 21 is rectified and converted to direct current power at the power transmission side rectification circuit 41, this direct current power is converted to alternating current power at the inverter 42, and this alternating current power is supplied to the power transmission side resonance circuit 43.

The power transmission side rectification circuit 41 is electrically connected to the power source 21 and inverter 42. The power transmission side rectification circuit 41 rectifies the alternating current power supplied from the power source 21 to convert it to direct current power, and supplies the direct current power to the inverter 42. The power transmission side rectification circuit 41 is, for example, an AC/DC converter.

The inverter 42 is electrically connected to the power transmission side rectification circuit 41 and power transmission side resonance circuit 43. The inverter 42 converts the direct current power supplied from the power transmission side rectification circuit 41 to an alternating current power of a frequency higher than the alternating current power of the power source 21 (high frequency power), and supplies the high frequency power to the power transmission side resonance circuit 43.

The power transmission side resonance circuit 43 has a resonator comprised of a coil 44 and capacitor 45. The various parameters of the coil 44 and capacitor 45 (outside diameter and inside diameter of the coil 44, the number of turns of the coil 44, electrostatic capacity of the capacitor 45, etc.) are determined so that the resonance frequency of the power transmission side resonance circuit 43 is a predetermined set value. The predetermined set value is, for example, 10 kHz to 100 GHz, preferably is the 85 kHz determined by the SAE TIR J2954 standard as the frequency band for noncontact power transfer.

As shown in FIG. 2, the power transmission side resonance circuit 43 is arranged at the center of the lane on which the vehicle 3 runs so that the center of the coil 44 is positioned at the center of the lane. If the high frequency power supplied from the inverter 42 is applied to the power transmission side resonance circuit 43, the power transmission side resonance circuit 43 generates an alternating magnetic field for power transmission. Note that, if the power source 21 is a direct current power supply, the power transmission side rectification circuit 41 may be omitted.

The controller 22 is one example of a control device for controlling the power transmission apparatus 4, The controller 22 is, for example, a general-purpose computer, and performs various control operations of the ground unit 20 of the ground power supplying apparatus 2. For example, the controller 22 is electrically connected to the inverter 42 of the power transmission apparatus 4, and controls the inverter 42 so as to control power transmission by the power transmission apparatus 4.

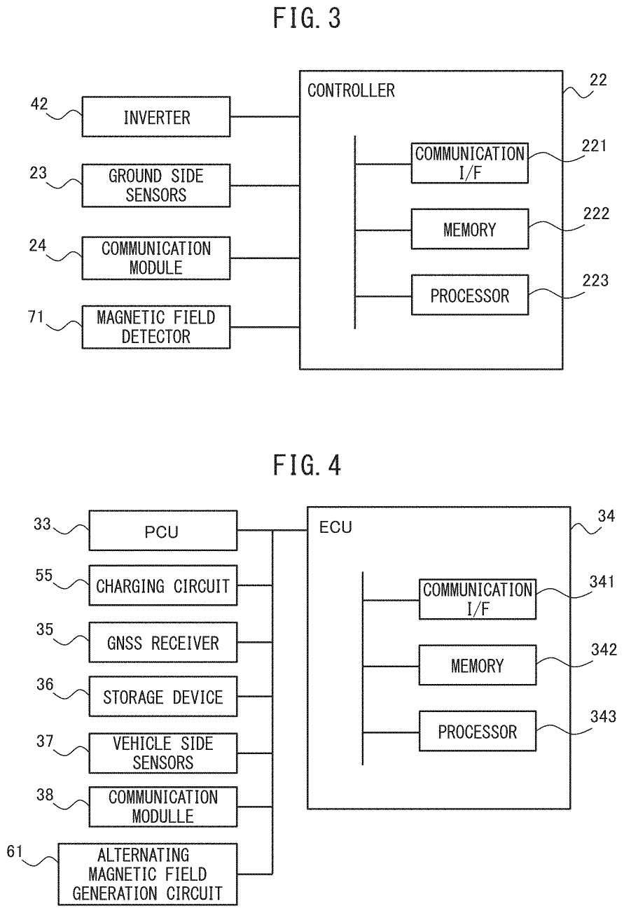

FIG. 3 is a schematic view of the configuration of the controller 22 and equipment connected to the controller 22. The controller 22 is provided with a communication interface 221, memory 222, and processor 223. The communication interface 221, memory 222, and processor 223 are electrically connected to each other through signal wires.

The communication interface 221 has an interface circuit for connecting the controller 22 to various equipment forming the ground unit 20 (for example, the inverter 42, later explained ground side sensors 23, communication module 24, etc.) The controller 22 communicates with other equipment through the communication interface 221.

The memory 222, for example, has a volatile semiconductor memory (for example, RAM) and nonvolatile semiconductor memory (for example, ROM). The memory 222 stores a computer program for performing various processing at the processor 223, and various data or the like used when various processing is performed by the processor 223. The memory 222, for example, stores vehicle information of a vehicle 3 being supplied with power and power transmission result information to the vehicle 3.

The processor 223 has one or more CPUs (central processing units) and their peripheral circuits. The processor 223 may further have a logic unit or arithmetic unit or other such processing circuit. The processor 223 performs various processing based on the computer program stored in the memory 222.

Further, as shown in FIG. 3, the ground power supply apparatus 2 is further provided with ground side sensors 23 and a communication module 24. The ground side sensors 23 detect the state of the ground power supply apparatus 2.

In the present embodiment, the ground side sensors 23, for example, include power transmission apparatus current sensors for detecting the current flowing through various equipment of the power transmission apparatuses 4 (in particular, the power transmission side resonance circuits 43, inverters 42, and power transmission side rectification circuits 41), and power transmission apparatus voltage sensors for detecting the voltage applied to various equipment of the power transmission apparatuses 4. The outputs of the ground side sensors 23 are input to the controllers 22.

A communication module 24 is equipment enabling communication with other ground units 20 of the ground power supply apparatus 2 or wide area communication with an outside server (not shown). Wide area communication is communication with a communication distance of about 10 meters to about 10 kilometers. For example, LTE (Long Term Evolution) is used as the wide area communication.

Note that, a power transmission apparatus 4 may also be configured so as to be able to receive power from the vehicle 3. In this case, the power transmission apparatus 4, in the same way as the later explained power reception apparatus 5 of the vehicle 3, has a device or circuit for supplying the received power to the power source 21. Further, in this case, the power transmission apparatus 4 may utilize the above-mentioned resonator comprised of a coil 44 and capacitor 45 so as to receive power from the vehicle 3.

Configuration of Vehicle

On the other hand, the vehicle 3, as shown in FIG. 1, has, in addition to the power reception apparatus 5, a motor 31, battery 32, power control unit (PCU) 33, and electronic control unit (ECU) 34. In the present embodiment, the vehicle 3 is an electric vehicle (BEV) using a motor 31 to drive the vehicle 3. However, the vehicle 3 may also be a hybrid vehicle (HEV) using not only a motor 31, but also an internal combustion engine to drive the vehicle 3.

The motor 31 is, for example, an alternating current synchronous motor, and functions as a motor and a generator. When the motor 31 functions as a motor, the power stored in the battery 32 is used as the source of power for driving the motor 31. The output of the motor 31 is transmitted through a decelerator and axle to the wheels 30. On the other hand, at the time of deceleration of the vehicle 3, the motor 31 is driven by rotation of the wheels 30, and the motor 31 functions as a generator to produce regenerated power.

The battery 32 is a rechargeable secondary battery and is, for example, comprised of a lithium ion battery, nickel-hydrogen battery, etc. The battery 32 stores the power required for the vehicle 3 to run (for example, drive power of motor 31). If power received by the power reception apparatus 5 from a power transmission apparatus 4 is supplied to the battery 32, the battery 32 is charged. Further, if the regenerated power produced by the motor 31 is supplied to the battery 32, the battery 32 is charged. If the battery 32 is charged, the state of charge (SOC) of the battery 32 is restored. Note that, the battery 32 can also be charged by an outside power source other than the ground power supply apparatus 2 through a charging port provided at the vehicle 3.

The PCU 33 is electrically connected to the battery 32 and motor 31. The PCU 33 has an inverter, booster converter, and DC/DC converter. The inverter converts the direct current power supplied from the battery 32 to alternating current power, and supplies the alternating current power to the motor 31. On the other hand, the inverter converts the alternating current power generated by the motor 31 (regenerated power) to direct current power, and supplies the direct current power to the battery 32. When the power stored in the battery 32 is supplied to the motor 31, the booster converter boosts the voltage of the battery 32 in accordance with need. When the power stored in the battery 32 is supplied to the headlights and other electronic equipment, the DC/DC converter lowers the voltage of the battery 32.

The power reception apparatus 5 receives power from a power transmission apparatus 4, and supplies the received power to the battery 32. The power reception apparatus 5 is provided with a power reception side resonance circuit 51, power reception side rectification circuit 54, and charging circuit 55.

The power reception side resonance circuit 51 is arranged at the bottom part of the vehicle 3 so that the distance from the road surface is smaller. In the present embodiment, the power reception side resonance circuit 51 is arranged at the center of the vehicle 3 in the vehicle width direction. The power reception side resonance circuit 51 has a configuration similar to the power transmission side resonance circuit 43, and has a resonator comprised of a coil 52 and capacitor 53. The various parameters of the coil 52 and capacitor 53 (outside diameter and inside diameter of the coil 52, the number of turns of the coil 52, electrostatic capacity of the capacitor 53, etc.) are determined so that the resonance frequency of the power reception side resonance circuit 51 matches the resonance frequency of the power transmission side resonance circuit 43. Note that, as long as the amount of deviation between the resonance frequency of the power reception side resonance circuit 51 and the resonance frequency of a power transmission side resonance circuit 43 is small, for example, the resonance frequency of the power reception side resonance circuit 51 is within a range of ±20% of the resonance frequency of the power transmission side resonance circuit 43, the resonance frequency of the power reception side resonance circuit 51 does not necessarily have to match the resonance frequency of the power transmission side resonance circuit 43.

As shown in FIG. 1, when the power reception side resonance circuit 51 faces a power transmission side resonance circuit 43, if an alternating magnetic field is generated at the power transmission side resonance circuit 43, the vibration of the alternating magnetic field is transferred to the power reception side resonance circuit 51 which resonates by the same resonance frequency of the power transmission side resonance circuit 43. As a result, due to electromagnetic induction, an induction current flows in the power reception side resonance circuit 51. Due to the induction current, induced electromotive power is generated at the power reception side resonance circuit 51. That is, the power transmission side resonance circuit 43 transmits power to the power reception side resonance circuit 51, and the power reception side resonance circuit 51 receives power from the power transmission side resonance circuit 43.

The power reception side rectification circuit 54 is electrically connected to the power reception side resonance circuit 51 and the charging circuit 55. The power reception side rectification circuit 54 rectifies the alternating current power supplied from the power reception side resonance circuit 51 to convert it to direct current power, and supplies the direct current power to the charging circuit 55. The power reception side rectification circuit 54 is, for example, an AC/DC converter.

The charging circuit 55 is electrically connected to the power reception side rectification circuit 54 and the battery 32. The charging circuit 55 converts the direct current power supplied from the power reception side rectification circuit 54 to the voltage level of the battery 32, and supplies it to the battery 32. If the power transmitted from the power transmission apparatus 4 is supplied by the power reception apparatus 5 to the battery 32, the battery 32 is charged. The charging circuit 55 is, for example, a DC/DC converter.

The ECU 34 performs various control of the vehicle 3. For example, the ECU 34 is electrically connected to the charging circuit 55 of the power reception apparatus 5, and controls the charging circuit 55 so as to control the charging of the battery 32 by power transmitted from a power transmission apparatus 4. Further, the ECU 34 is electrically connected to the PCU 33 and controls the PCU 33 to control the transfer of power between the battery 32 and motor 31. Further, the ECU 34 controls the later explained signal emission device 6.

FIG. 4 is a schematic view of the configuration of the ECU 34 and equipment connected to the ECU 34. The ECU 34 has a communication interface 341, memory 342, and processor 343. The communication interface 341, memory 342, and processor 343 are connected to each other through signal wires.

The communication interface 341 has an interface circuit for connecting the ECU 34 to an internal vehicle network based on the CAN (Controller Area Network) or other standard. The ECU 34 communicates with other equipment through the communication interface 341.

The memory 342, for example, has a volatile semiconductor memory (for example, RAM) and nonvolatile semiconductor memory (for example, ROM). The memory 342 stores, for example, computer programs for performing various processing at the processor 343, and various data used when various processing is performed by the processor 343.

The processor 343 has one or more CPUs (central processing units) and their peripheral circuits. The processor 343 may also have a logic unit or arithmetic unit or other such processing circuit. The processor 343 performs various processing based on a computer program stored in the memory 342.

Further, as shown in FIG. 4, the vehicle 3 is further provided with a GNSS receiver 35, storage device 36, a plurality of vehicle side sensors 37, and a communication module 38. The GNSS receiver 35, storage device 36, vehicle side sensors 37, and communication module 38 are electrically connected to the ECU 34 through an internal vehicle network.

The GNSS receiver 38 detects the current position of the vehicle 3 (for example, a latitude and longitude of the vehicle 3), based on position measurement information obtained from a plurality of (for example, three or more) positioning satellites. Specifically, the GNSS receiver 38 captures a plurality of positioning satellites, and receives signals emitted from the positioning satellites. Further, the GNSS receiver 35 calculates the distances to the positioning satellites based on the difference between the times of emission and times of reception of the signals, and detects the current position of the vehicle 3 based on the distances to the positioning satellites and the positions of the positioning satellites (orbital information). The output of the GNSS receiver 35, that is, the current position of the vehicle 3 detected by the GNSS receiver 35, is sent to the ECU 34. As the GNSS receiver 35, for example, a GPS receiver is used.

The storage device 36 stores data. The storage device 36 is provided with, for example, a hard disk drive (HDD), solid state drive (SSD), or optical recording medium. In the present embodiment, the storage device 36 stores map information. The map information includes, in addition to information relating to the roads, information on the installation positions of ground power supply apparatuses 2 and other information. The ECU 34 acquires map information from the storage device 36. Note that, the storage device 36 need not store map information. In this case, the ECU 34 may acquire map information from the outside of the vehicle 3 (for example, an outside server) through the communication module 38.

The vehicle side sensors 37 detect the state of the vehicle 3. In the present embodiment, the vehicle side sensors 37 include, as sensors for detecting the state of the vehicle 3, a power reception apparatus current sensor for detecting the current flowing through various equipment of the power reception apparatus 5 and a power reception apparatus voltage sensor for detecting the voltage applied to various equipment of the power reception apparatus 5. The outputs of the vehicle side sensors 37 are input to the ECU 34.

The communication module 38 is equipment enabling wide area communication between the vehicle 3 and an outside server (not shown), for example, is a data communication module (DCM).

Note that, the power reception apparatus 5 may also be configured so as to enable transmission of power to the ground power supply apparatus 2. In this case, the power reception apparatus 5, in the same way as a power transmission apparatus 4 of the ground power supply apparatus 2, is configured so as to transmit power of the battery 32 to the ground power supply apparatus 2. Further, in this case, the power reception apparatus 5 may utilize the resonator comprised of the above-mentioned coil 52 and capacitor 53 to transmit power to the ground power supply apparatus 2.

Configuration of Signal Transfer System

As explained above, the noncontact power supply system 1 transfers power from the ground power supply apparatus 2 to the vehicle 3 through an alternating magnetic field generated at a power transmission side resonance circuit 43 of a power transmission apparatus 4. In order to transfer power by noncontact in this way, it is necessary to transmit vehicle information from the running vehicle 3 to the ground power supply apparatus 2, and have the ground power supply apparatus 2 control the power transmission apparatus 4 based on this vehicle information. For this reason, the noncontact power supply system 1 of the present embodiment has a signal transfer system for transmitting a signal including vehicle information from the vehicle 3 to the ground power supply apparatus 2.

Note that, vehicle information is information of the vehicle 3 relating to power transfer, and includes vehicle identification information for identifying the vehicle 3 such as a vehicle ID. The vehicle information, for example, includes the power (or electrical energy) requested to be received from the ground power supply apparatus 2, that is, the vehicle requested power (or the vehicle requested electrical energy). The vehicle requested power is calculated in the ECU 34 of the vehicle 3. Further, the vehicle information may include information relating to the state of the vehicle, such as the state of the power reception apparatus 5 (state of connection of battery 32 and power reception apparatus 5), state of charge SOC of the battery 32, temperature of the battery 32 and allowable charged power Win. In this case, the state of charge SOC of the battery 32 is calculated at the ECU 34, based on the value of the charged current and value of the discharged current of the battery 32 detected by a vehicle side sensor 37 (battery current sensor). Further, the temperature of the battery 32 is detected by a vehicle side sensor 37 (battery temperature sensor). Further, the allowable charged power Win indicates the maximum value of the charged power not causing precipitation of metal lithium at the surface of the negative electrode of a lithium ion battery. This allowable charged power Win is calculated at the ECU 34 based on the charging history of the battery 32, the state of charge SOC of the battery 32, and the temperature of the battery 32.

The signal transfer system has a signal emission device 6 for emitting a signal including vehicle information from the vehicle 3 to the ground power supply apparatus 2 using narrow range wireless communication, and signal detection devices 7 for detecting a signal emitted from the signal emission device 6. The signal emission device 6 is provided at the vehicle 3. In the present embodiment, it is arranged at the front from the power reception apparatus 5 in the direction of advance of the vehicle 3. On the other hand, the signal detection devices 7 may, for example, be buried in the road 100, or may be arranged at separate locations from inside the road 100. The signal detection devices 7, in the present embodiment, are arranged so as to be able to detect a signal from the vehicle when the vehicle 3 is positioned at an upstream side from the power transmission apparatuses 4 of the same ground units 20 in the direction of advance of the vehicle 3. For example, as shown in FIG. 1, the signal detection devices 7 are arranged at upstream sides from the power transmission apparatuses 4 of the same ground units 20 in the direction of advance of the vehicle 3.

In the present embodiment, the signal emission device 6 has an alternating magnetic field generation circuit 62 for generating an alternating magnetic field, and an alternating current generation circuit 61 for supplying an alternating current (or alternating current power) to the alternating magnetic field generation circuit. Further, the signal detection devices 7 have magnetic field detectors 71 for detecting a magnetic field and receiving circuits 72 for retrieving information from the signal included in the detected magnetic field.

The alternating current generation circuit 61 is electrically connected to the battery 32 and alternating magnetic field generation circuit 62. The alternating current generation circuit 61, for example, has an oscillation circuit, modulation circuit, and amplification circuit. The alternating current generation circuit 61 generates a carrier wave by the oscillation circuit, modulates it by the modulation circuit in accordance with the vehicle information, amplifies the modulated carrier wave by the amplification circuit, and supplies the alternating current (alternating current power) to the alternating magnetic field generation circuit 62.

As shown in FIG. 1, the alternating current generation circuit 61 is electrically connected to the ECU 34. The ECU 34 controls the alternating current generation circuit 61. The alternating current generation circuit 61 converts the direct current supplied from the battery 32 to alternating current including a signal corresponding to the vehicle information transmitted from the ECU 34, and supplies this alternating current to the alternating magnetic field generation circuit 62.

The alternating magnetic field generation circuit 62 generates an alternating magnetic field including a signal of the vehicle information or the like. The alternating magnetic field generation circuit 62 is arranged at the bottom part of the vehicle 3 so that the distance from the road surface is smaller. In the present embodiment, the alternating magnetic field generation circuit 62 is arranged at the center of the vehicle 3 in the vehicle width direction, and is arranged at the front from the power reception side resonance circuit 51 in the front-rear direction of the vehicle 3. Note that, the alternating magnetic field generation circuit 62 may be arranged at the same position as or at the rear from the power reception side resonance circuit 51 in the front-rear direction of the vehicle 3.

The alternating magnetic field generation circuit 62 has a coil 63 generating an alternating magnetic field if an alternating current is supplied from the alternating current generation circuit 61. Therefore, the alternating magnetic field generation circuit 62 acts as an antenna generating an alternating magnetic field.

The magnetic field detectors 71 detect the magnetic field of the surroundings. The magnetic field detectors 71 are, for example, magneto-impedance (MI) sensors. The drive power of the magnetic field detectors 71 is, for example, supplied from the power source 21 to the magnetic field detectors 71 though the drive circuits. Note that, the magnetic field detectors 71 may be Hall sensors, magneto resistive effect (MR) sensors, etc.

The magnetic field detectors 71, as shown in FIG. 1, are arranged at the front (upstream side) from the power transmission side resonance circuits 43 of the power transmission apparatuses 4 in the direction of advance of the vehicle 3, on the road 100 at which the power transmission apparatuses 4 are provided. Further, they are arranged at the center in a direction perpendicular to the direction of advance of the vehicle 3. Further, the magnetic field detectors 71 are arranged in the ground (below the road surface) or on the road surface.

The receiving circuits 72 retrieve information from the magnetic field detected by the magnetic field detectors 71. The receiving circuits 72 have amplification circuits and demodulation circuits. The receiving circuits 72 amplify, by the amplification circuits, the weak current generated by the magnetic field detected by the magnetic field detectors 71, and demodulate the amplified signal by the demodulation circuits to thereby retrieve information (which is, in this case, vehicle information including vehicle identification information) from the signal included in the magnetic field.

The receiving circuits 72 are electrically connected to the controllers 22. The outputs of the receiving circuits 72 are transmitted to the controllers 22. The controllers 22 acquire the vehicle information transmitted from the vehicle 3 based on the outputs of the receiving circuits 72, and control the ground power supply apparatus 2 based on this vehicle information.

Note that, in the signal transfer system of the present embodiment, as narrow range wireless communication with a short communication distance from the vehicle 3 to the ground power supply apparatus 2, communication through a magnetic field is used. However, instead of a magnetic field, narrow range wireless communication using electric waves may also be used. As narrow range wireless communication using electric waves, various near field wireless communication schemes with short communication distances can be used. For example, communication based on any communication standard formulated by the IEEE, ISO, IEC, etc. (for example, Bluetooth® or ZigBee®) can be used. Further, as art for narrow range wireless communication, for example, RFID (Radio Frequency Identification), DSRC (Dedicated Short Range Communication), etc., can be used.

In this case, the signal emission device 6 has an antenna for generating electric waves and an alternating current generation circuit for supplying the antenna with alternating current (or alternating current power). The alternating current generation circuit generates an alternating current including a signal corresponding to the vehicle information. By this alternating current being supplied to the antenna, an electric wave including a signal corresponding to the vehicle information is emitted from the antenna. Further, the signal detection devices 7 have antennas for receiving electric waves and receiving circuits for retrieving information from the electric waves which the antennas receive.

Further, in the present embodiment, all of the vehicle information is transmitted from the vehicle 3 to the ground power supply apparatus 2 by a signal transfer system utilizing narrow range wireless communication. However, part of the vehicle information is also transmitted from the vehicle 3 to the ground power supply apparatus 2 by wide area wireless communication through the communication module 38 of the vehicle 3 and the communication module 24 of the ground power supply apparatus 2. In this case as well, at least the vehicle identification information, or at least the vehicle identification information and the vehicle requested power, in the vehicle information, are transmitted by the signal transfer system from the vehicle 3 to the ground power supply apparatus 2.

Arrangement of Plurality of Ground Units

As explained above, the ground power supply apparatus 2 according to the present embodiment has a plurality of ground units 20. As shown in FIGS. 1 and 2, the ground units 20 respectively have power transmission apparatuses 4, signal detection devices 7, and controllers 22. The power transmission apparatus 4 and the signal detection devices 7 of the ground units 20 are connected to the controllers 22 of the ground units 20. Therefore, the power transmission apparatuses 4 and the signal detection devices 7 of the ground units 20 are controlled by the controllers 22 of the ground units 20.

As shown in FIG. 2, the plurality of ground units 20 are arranged aligned in the direction of advance of the vehicle 3. Specifically, the plurality of ground units 20 of the ground power supply apparatus 2 are arranged aligned along a single lane of the road 100.

More specifically, the power transmission apparatuses 4 of the plurality of ground units 20 are arranged aligned in the direction of advance of the vehicle 3. The power transmission apparatuses 4 of the plurality of ground units 20 are arranged aligned in the same lane toward the direction of advance of the vehicle 3. As explained above, the power transmission apparatuses 4 are buried at the center of the lane.

Further, as explained above, the signal detection devices 7 of the ground units 20 (in particular, magnetic field detectors 71) are arranged so as to be able to detect a signal from the vehicle 3 at the upstream side from the power transmission apparatuses 4 of the ground units 20 in the direction of advance of the vehicle 3. In particular, in the present embodiment, the signal detection device 7 of the ground unit 20 (in particular, magnetic field detector 71) is arranged at the upstream side from the power transmission apparatuses 4 of the same ground unit 20 in the direction of advance of the vehicle 3. However, in the present embodiment, the signal detection device 7 of the ground unit 20 is arranged at the downstream side from power transmission apparatuses 4 of another ground unit 20 positioned one place at the upstream side of the ground unit 20. Therefore, in the present embodiment, at the road, the signal detection devices 7 and the power transmission apparatuses 4 are alternately arranged aligned in the direction of advance of the vehicle 3.

Note that, in this Description, among the ground units 20 contained in one ground power supply apparatus 2, the ground unit positioned at the most upstream side in the direction of advance of the vehicle 3 will be referred to as the “first ground unit 20A”, and the ground units arranged in order from the first ground unit toward the downstream side will be referred to as the “second ground unit 20B”, “third ground unit 20C”, . . . . Further, the power transmission apparatus 4 of the first ground unit 20A will be referred to as the “first power transmission apparatus 4A”, and the signal detection device 7 of the first ground unit 20A will be referred to as the “first signal detection device 7A”. In addition, in downstream of the second ground unit 20B, the power transmission apparatuses 4 and the signal detection devices 7 will be similarly named.

Further, as shown in FIG. 2, in the present embodiment, the controllers 22 of different ground units 20 arranged aligned on the road are connected to be able to communicate with each other. Therefore, the first controller 22A of the first ground unit 20A can transmit vehicle information of the vehicle 3 detected by the first signal detection device 7A of the first ground unit 20A, to the controllers 22 of the ground units positioned at the downstream side from the first ground unit 20A (second ground unit, third ground unit, . . . )

Control of Power Transmission in Ground Units

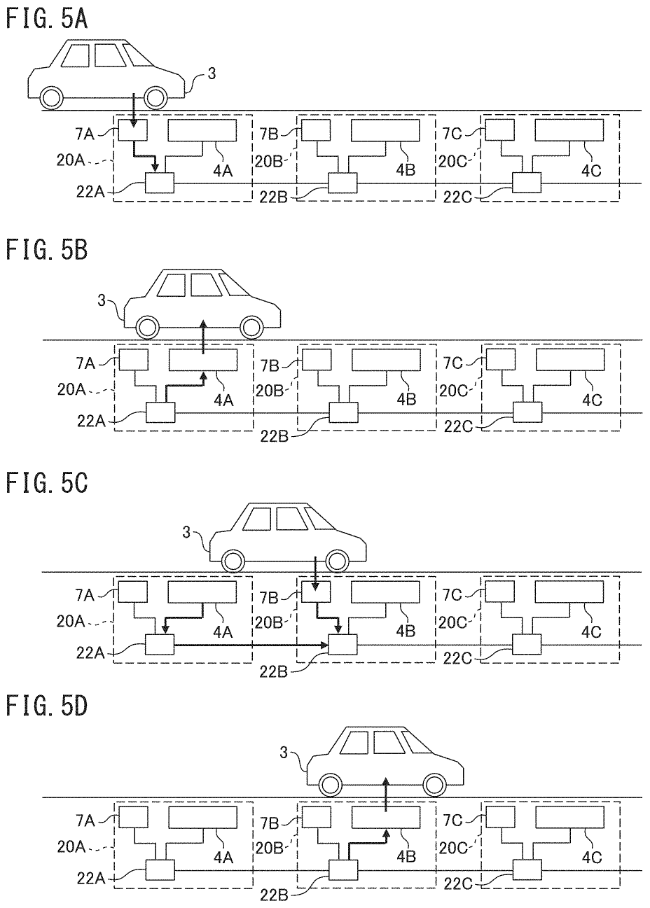

Next, referring to FIGS. 5A to 5D, the basic control of power transmission at a ground unit 20 will be explained. FIGS. 5A to 5D are views schematically showing a way of transmission of information in a ground power supply apparatus 2 having a plurality of ground units 20.

When the distance between the installation position of the ground power supply apparatus 2 and the vehicle 3 becomes less than or equal to a predetermined value, the ECU 34 of the vehicle 3 controls the alternating current generation circuit 61 to generate an alternating magnetic field including a signal of the vehicle information, etc., by the alternating magnetic field generation circuit 62 at predetermined time intervals. The distance between the installation position of the ground power supply apparatus 2 and the vehicle 3 is, for example, calculated by comparing the current position of the vehicle 3 detected by the GNSS receiver 35 and the installation position of the ground power supply apparatus 2 stored in the storage device 36. Further, in the present embodiment, the vehicle information included in the alternating magnetic field includes the vehicle identification information of the vehicle 3 and the vehicle requested power to the ground power supply apparatus 2.

The vehicle 3 approaching the ground power supply apparatus 2, as shown in FIG. 5A, first, reaches the vicinity of the first signal detection device 7A of the first ground unit 20A. If the vehicle 3 reaches the vicinity of the first signal detection device 7A, the alternating magnetic field generated by the alternating magnetic field generation circuit 62 of the vehicle 3 is detected by the magnetic field detector 71 of the first signal detection device 7A. If a magnetic field is detected by the magnetic field detector 71, the vehicle information of the vehicle 3 contained in the detected magnetic field is retrieved by the receiving circuit 72. If vehicle information of the vehicle 3 reaching the ground power supply apparatus 2 is retrieved in this way, the vehicle information is transmitted to the first controller 22A.

When the first controller 22A of the first ground unit 20A receives the vehicle information, as shown in FIG. 5B, it controls the first power transmission apparatus 4A of the first ground unit 20A, based on that vehicle information. Specifically, the first controller 22A controls the first power transmission apparatus 4A, for example, based on the vehicle requested power from the vehicle 3 so that power corresponding to the vehicle requested power is supplied from the first power transmission apparatus 4A to the power reception apparatus 5 of the vehicle 3 while the power reception apparatus 5 is positioned over the first power transmission apparatus 4A. If the vehicle 3 advances and the power reception apparatus 5 of the vehicle 3 reaches the vicinity of the first power transmission apparatus 4A in the state where the first controller 22A is controlling the first power transmission apparatus 4A in this way, power is transmitted from the first power transmission apparatus 4A to the power reception apparatus 5.

If the vehicle 3 further advances and the power reception apparatus 5 of the vehicle 3 moves away from the first power transmission apparatus 4A, power transmission from the first power transmission apparatus 4A to the power reception apparatus 5 ends. During power transmission from the first power transmission apparatus 4A, the measured values of the ground side sensors 23 for detecting the current, voltage, etc., at the power transmission side resonance circuit 43 are transmitted to the first controller 22A, therefore the first controller 22A calculates data relating to power transmission from the first power transmission apparatus 4A to the power reception apparatus 5, based on these measured values as power transmission result information. Such power transmission result information includes, for example, the electrical energy consumed along with transmission of power from the first power transmission apparatus 4A to the power reception apparatus 5. If calculating the power transmission result information, the first controller 22A transmits the calculated power transmission result information, together with the vehicle information detected by the first signal detection device 7A, to the second controller 22B.

Then, if further advancing, the vehicle 3 reaches the vicinity of the second signal detection device 7B of the second ground unit 20B, as shown in FIG. 5C. If the vehicle 3 reaches the vicinity of the second signal detection device 7B, the alternating magnetic field generated by the alternating magnetic field generation circuit 62 of the vehicle 3 is detected by the magnetic field detector 71 of the second signal detection device 7B. If the magnetic field is detected by the magnetic field detector 71, the vehicle information of the vehicle 3 included in the detected magnetic field is transmitted to the second controller 22B.

In this way, the vehicle information detected by the first signal detection device 7A and the power transmission result information are transmitted from the first controller 22A to the second controller 22B, and the vehicle information is transmitted from the second signal detection device 7B to the second controller 22B. In the present embodiment, the second controller 22B controls the second power transmission apparatus 4B based on the received vehicle information and the like, as shown in FIG. 5D.

In particular, in the present embodiment, when receiving vehicle information and the like from both of a signal detection device 7 in a certain ground unit 20 and a controller 22 of a ground unit 20 at the upstream side from that ground unit 20, the controller 22 of that ground unit 20 controls the power transmission apparatus 4 based on the vehicle information transmitted from the signal detection device 7 of that ground unit 20. Due to this, it is possible to control the power transmission apparatus 4 based on the latest vehicle information of the vehicle 3. Therefore, in the example shown in FIG. 5D, the second controller 22B of the second ground unit 20B controls the second power transmission apparatus 4B of the second ground unit 20B, based on the vehicle information transmitted from the second signal detection device 7B.

On the other hand, if there is an obstacle between the signal emission device 6 and the second signal detection device 7B, for example, if there is water pooled on the second signal detection device 7B or otherwise, sometimes the second signal detection device 7B cannot detect the signal emitted by the signal emission device 6. In such a case, the second controller 22B of the second ground unit 20B controls the second power transmission apparatus 4B of the second ground unit 20B, based on the vehicle information and power transmission result information transmitted from the first controller 22A. Due to this, even if a signal is not detected by the second signal detection device 7B, it is possible to suitably control the power transmission apparatus 4.

Here, the vehicle requested power changes in accordance with the state of charge (SOC) of the battery 32 of the vehicle 3. If the state of charge of the battery 32 is higher than a certain constant value, the higher the state of charge, the lower the vehicle requested power. Therefore, sometimes the vehicle requested power when the vehicle 3 is running over the first ground unit 20A and the vehicle requested power when the vehicle 3 is running over the second ground unit 20B will differ. Therefore, if controlling the second power transmission apparatus 4B based on information transmitted from the first controller 22A, the second controller 22B of the second ground unit 20B estimates the current vehicle requested power (vehicle requested power when passing over second ground unit 20B), based on the past vehicle requested power (vehicle requested power when passing over first ground unit 20A) and power transmission result information transmitted from the first controller 22A. Specifically, if the past vehicle requested power was less than or equal to a certain reference value, the second controller 22B lowers the vehicle requested power as the transmitted electrical energy at the first ground unit 20A becomes larger. Note that, the vehicle requested power was explained as an example, but other parameters relating to power transmission may also be estimated based on the past values when passing over the first ground unit 20A and the power transmission result information.

Further, if the vehicle 3 advances and the power reception apparatus 5 of the vehicle 3 reaches the vicinity of the second power transmission apparatus 4B in the state where the second controller 22B controls the second power transmission apparatus 4B based on the received vehicle information, power is transmitted from the second power transmission apparatus 4B to the power reception apparatus 5. Further, if the vehicle 3 further advances and the power reception apparatus 5 of the vehicle 3 moves away from the second power transmission apparatus 4B and power transmission from the second power transmission apparatus 4B to the power reception apparatus 5 ends, the second controller 22B calculates the power transmission result information and transmits the calculated power transmission result information together with the vehicle information detected by the second signal detection device 7B, or the vehicle information and power transmission result information received from the first controller 22A, to the third controller 22C.

The power transmission apparatuses 4 are controlled in the third ground unit 20C and following ground units 20 as well similarly to the second ground unit 20B. Therefore, in the third ground unit 20C and following ground units 20, if the signal detection device 7 of a ground unit 20 detects a signal from the vehicle 3, the controller 22 of that ground unit 20 controls the power transmission apparatus 4 of the ground unit 20, based on the vehicle information contained in the detected signal. On the other hand, if the signal detection device 7 of a ground unit 20 cannot detect a signal from the vehicle 3, the controller 22 of that ground unit 20 controls the power transmission apparatus 4 of that ground unit 20, based on the vehicle information contained in the signal detected at the upstream side ground unit 20 (in particular, the vehicle information contained in the signal detected by the most downstream side ground unit 20 among the upstream side ground units 20 receiving vehicle information), and the power transmission result information at the downstream side ground unit 20 from the ground unit 20 receiving the vehicle information.

Therefore, in the present embodiment, a controller 22 for controlling a power transmission apparatus 4 of a ground unit 20 provided at a second place and following places from the upstream side in the direction of advance of the vehicle 3 controls the power transmission apparatus 4 of that ground unit 20, based on the vehicle information included in the signal which the signal detection device 7 of that ground unit 20 detects, regardless of the vehicle information contained in the signal which the first signal detection device 7A positioned the most upstream detects and power transmission result information in the power transmission apparatus 4 of the ground unit 20 positioned at the upstream side from that ground unit 20, when a signal detection device 7 of that ground unit 20 detects a signal including the vehicle information.

In addition, in the present embodiment, a controller 22 for controlling a power transmission apparatus 4 of a ground unit 20 provided at a third place and following places from the upstream side in the direction of advance of the vehicle 3 controls the power transmission apparatus 4 of that ground unit 20, based on vehicle information included in a signal detected by a signal detection device 7 of an intermediate ground unit 20 downstream from a most upstream first ground unit 20A having a first detection device 7A positioned the most upstream and upstream from that ground unit 20, and power transmission result information in the signal detection device 7 of the ground unit 20 downstream from this intermediate ground unit 20 and upstream from that ground unit 20, when the signal detection device 7 of that ground unit does not detect a signal from the vehicle 3 and a signal detection device 7 of the intermediate ground unit 20 detects a signal including the vehicle information.

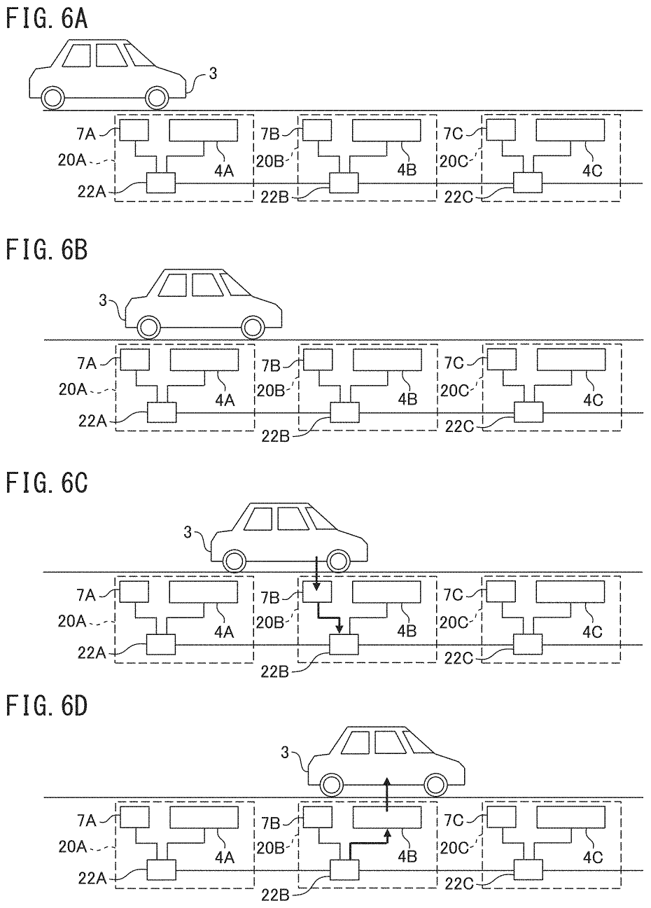

FIGS. 6A to 6D are views, similar to FIGS. 5A to 5D, schematically showing a way of transmission of information in a ground power supply apparatus 2 having a plurality of ground units 20. FIGS. 6A to 6D show the case where the first signal detection device 7A of the first ground unit 20A could not detect a signal emitted from the signal emission device 6.

The vehicle 3 approaching the ground power supply apparatus 2, as shown in FIG. 6A, first reaches near the first signal detection device 7A of the first ground unit 20A. However, in the example shown in FIG. 6A, the alternating magnetic field generated by the alternating magnetic field generation circuit 62 of the vehicle 3 is not detected by the magnetic field detector 71 of the first signal detection device 7A. Therefore, the first controller 22A of the first ground unit 20A does not receive the vehicle information of the vehicle 3.

Since the first controller 22A does not receive the vehicle information of the vehicle 3, the first power transmission apparatus 4A is maintained as stopped. Therefore, as shown in FIG. 6B, even if the vehicle 3 advances and the power reception apparatus 5 of the vehicle 3 is positioned over the first power transmission apparatus 4A, the first controller 22A controls the first power transmission apparatus 4A so as not to allow power transmission from the first power transmission apparatus 4A to the power reception apparatus 5. Therefore, even if the vehicle 3 advances and moves away from the first ground unit 20A, the first controller 22A does not transmit the vehicle information of the vehicle 3 or the power transmission result information to the second controller 22B.

Then, the vehicle 3 further advances and, as shown in FIG. 6C, reaches near the second signal detection device 7B of the second ground unit 20B. In the example shown in FIG. 6C, at this time, the signal emitted from the signal emission device 6 of the vehicle 3 (alternating magnetic field) is detected by the second signal detection device 7B, and the vehicle information included in that signal is transmitted to the second controller 22B. Therefore, the second controller 22B receives vehicle information from the second signal detection device 7B, but does not receive vehicle information from the first controller 22A. For this reason, the second controller 22B controls, as shown in FIG. 5D, the second power transmission apparatus 4B of the second ground unit 20B, based on the vehicle information transmitted from the second signal detection device 7B.

Note that, in the example shown in FIGS. 6A to 6D, the second signal detection device 7B of the second ground unit 20B detects a signal. However, sometimes the signal detection device 7 of the second ground unit 20B or following ground units 20 cannot detect a signal. In this case, the controller 22 of the second ground unit 20B or later ground unit 20 controls the power transmission apparatus 4 so as not to allow power transmission from the power transmission apparatus 4 to the power reception apparatus 5. In this case, the controller 22 of the second ground unit 20B or later ground unit 20 does not transmit vehicle information of the vehicle 3 or power transmission result information to the controller of the downstream side ground unit 20.

Therefore, in the present embodiment, when vehicle information is not detected by the signal detection device 7 of a ground unit 20 and the signal detection device 7 of the ground unit arranged at the upstream side of that ground unit, the controller 22 controlling the power transmission apparatus 4 of that ground unit 20 does not allow transmission of power from the power transmission apparatus 4 of that ground unit to the vehicle 3.

Flow of Control Processing

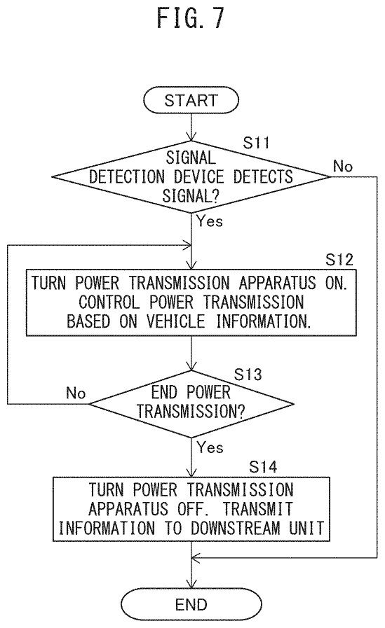

FIG. 7 is a flow chart showing a flow of control processing of a ground unit 20 by a controller 22 of a ground unit 20 positioned at an upstream most of a ground power supply apparatus 2 (first ground unit 20A).

First, the controller 22 judges if the signal detection device 7 of the ground unit 20 has detected a signal including vehicle information (step S11). If at step S11 it is judged that the signal detection device 7 has not detected a signal including vehicle information, the control processing is ended.

On the other hand, if at step S11 it is judged that the signal detection device 7 has detected a signal including vehicle information, the controller 22 actuates the power transmission apparatus 4 (step S12). Specifically, the controller 22 controls the inverter 42 so as to supply alternating current power to the power transmission side resonance circuit 43. In particular, in the present embodiment, at the time of start of operation of the power transmission apparatus 4, the inverter 42 is controlled so as to supply a weak alternating current power to the power transmission side resonance circuit 43. Then, if the current supplied to the power transmission apparatus 4 increases due to the approach of the power reception side resonance circuit 51 of the vehicle 3, the inverter 42 is controlled so as to supply a large alternating current power to the power transmission side resonance circuit 43. In particular, at this time, the inverter 42 is controlled so as to supply alternating current power based on the vehicle information, for example, so that the power supplied to the power transmission side resonance circuit 43 becomes greater as the vehicle requested power contained in the vehicle information becomes greater.

Then, the controller 22 judges if power transmission from the power transmission apparatus 4 to the vehicle 3 has ended (step S13). For example, the controller 22 judges that power transmission to the vehicle 3 has ended when the power consumed at the power transmission apparatus 4 becomes smaller after once becoming larger. Alternatively, when it is detected, by a passage detection sensor (not shown) provided at the downstream side from the power transmission apparatus 4, that the vehicle 3 has passed, the controller 22 judges that power transmission to the vehicle 3 has ended. If at step S13 it is judged that power transmission from the power transmission apparatus 4 to the vehicle 3 has not ended, step S12 is repeatedly performed.

On the other hand, if at step S13 it is judged that power transmission from the power transmission apparatus 4 to the vehicle 3 has ended, the controller 22 makes the power transmission apparatus 4 stop operating and transmits information to the controller 22 of the downstream side ground unit 20 (second ground unit 20B) (step S14). The information which the controller 22 transmits includes, for example, the vehicle information included in the signal detected by the signal detection device 7 and power transmission result information to the vehicle 3 in the power transmission apparatus 4 (for example, the electrical energy consumed along with transmission of power to the vehicle 3)

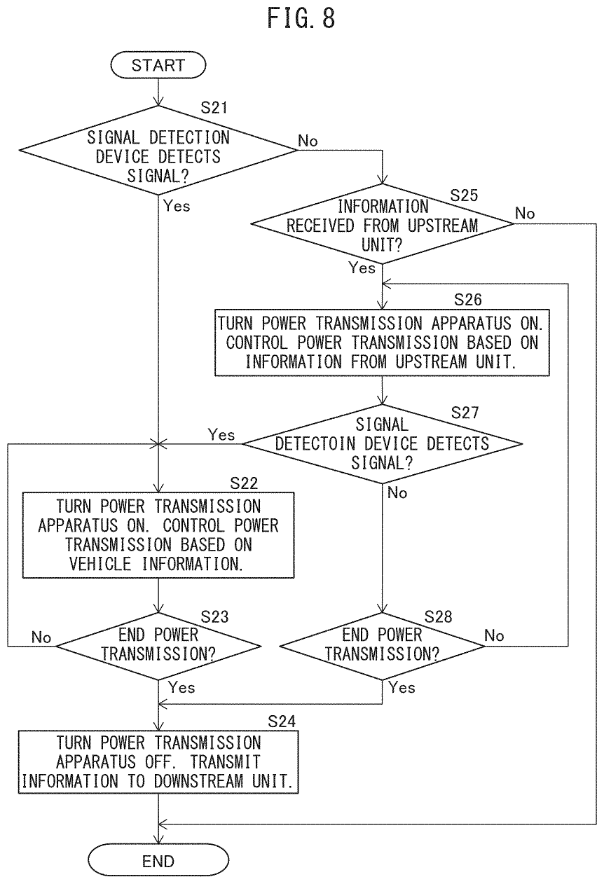

FIG. 8 is a flow chart showing a flow of control processing by the controller 22 of the ground units 20 at the downstream side from the ground unit 20 positioned at the upstream most of the ground power supply apparatus 2 (the second ground unit 20B and the ground units at downstream side of the same).

First, the controller 22 judges whether the signal detection device 7 of a ground unit 20 has detected a signal including vehicle information (step S21). If at step S21 it is judged that the signal detection device 7 has detected a signal including vehicle information, the controller 22, similarly to step S12, actuates the power transmission apparatus 4 (step S22). In particular, the controller 22 controls the power transmission apparatus 4 based on the vehicle information included in the signal detected by the signal detection device 7. Then, the controller 22, similarly to step S13, judges whether power transmission from the power transmission apparatus 4 to the vehicle 3 has ended (step S23). If at step S23 it is judged that power transmission from the power transmission apparatus 4 to the vehicle 3 has not ended, step S22 is repeatedly performed. On the other hand, if at step S23 it is judged that power transmission from the power transmission apparatus 4 to the vehicle 3 has ended, the controller 22, similarly to step S14, makes the power transmission apparatus 4 stop operating and transmits the vehicle information and power transmission result information to the controller 22 of the downstream side ground unit 20 (step S24).

On the other hand, if at step S21 it is judged that the signal detection device 7 has not detected a signal including vehicle information, the controller 22 judges whether it has received vehicle information and power transmission result information from the upstream side ground unit 20 in the ground power supply apparatus 2 (step S25). If at step S25 it is judged that it has not received information from the upstream side ground unit 20, the control processing is ended.

On the other hand, if at step S25 it is judged that it has received vehicle information and power transmission result information from the upstream side ground unit 20, the controller 22 actuates the power transmission apparatus 4 (step S26). At this time, the controller 22, similarly to step S22, first, controls the inverter 42 so as to supply weak alternating current power to the power transmission side resonance circuit 43. Then, if the current supplied to the power transmission apparatus 4 increases due to the approach of the power reception side resonance circuit 51 of the vehicle 3, the controller 22 controls the power transmission apparatus 4, in particular the inverter 42, based on the vehicle information and power transmission result information received from the upstream side ground unit 20.

Next, the controller 22 judges whether the signal detection device 7 has detected a signal including vehicle information while a weak alternating current power is being supplied to the power transmission side resonance circuit 43 due to step S26 (step S27). If at step S27 it is judged that the signal detection device 7 has detected a signal including vehicle information, when the current supplied to the power transmission apparatus 4 increases due to the approach of the power reception side resonance circuit 51 of the vehicle 3, the controller 22 controls the power transmission apparatus 4, in particular the inverter 42, based on the vehicle information included in the signal detected by the signal detection device 7.

On the other hand, if at step S27 it is not judged that the signal detection device 7 has detected a signal including vehicle information, the controller 22 judges whether power transmission from the power transmission apparatus 4 to the vehicle 3 has ended (step S28). If at step S13 it is judged that the power transmission from the power transmission apparatus 4 to the vehicle 3 has not ended, steps S26 and S27 are repeatedly performed. On the other hand, if at step S28 it is judged that power transmission from the power transmission apparatus 4 to the vehicle 3 has ended, the controller 22 makes the power transmission apparatus 4 stop operating and transmits, to the controller 22 of the downstream side ground unit 20, the vehicle information received from the upstream side ground unit 20 and the power transmission result information to the vehicle 3 at this ground unit 20 and the upstream side ground unit 20 (step S24).

Modification

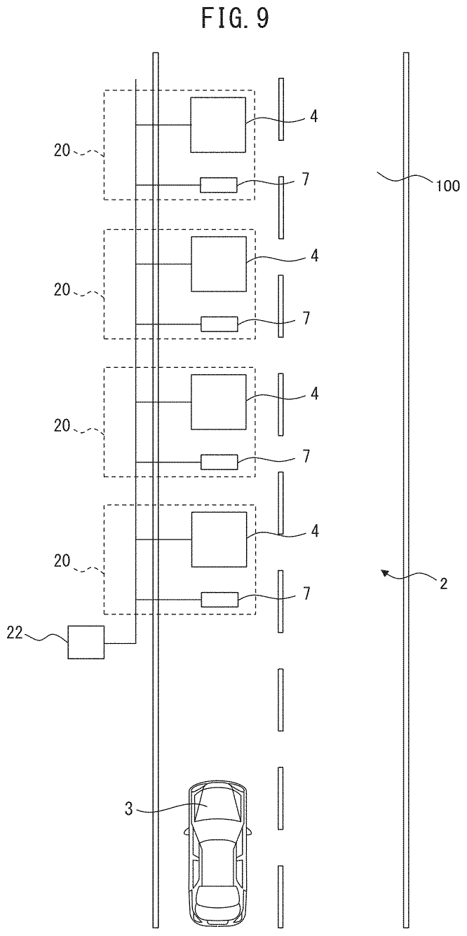

Next, referring to FIG. 9, a modification of the noncontact power supply system 1 will be explained. FIG. 9 is a view, similar to FIG. 2, schematically showing a ground power supply apparatus 2 provided at a road.

In the ground power supply apparatus 2 according to the above embodiments, the ground units 20 had controllers 22 respectively. However, in the ground power supply apparatuses 2 according to the present modification, as shown in FIG. 9, the ground units 20 do not have controllers 22 respectively. The ground power supply apparatuses 2 have a single common controller 22.

Therefore, in the present modification, the ground units 20 have power transmission apparatuses 4, power sources 21, and signal detection devices 7. The power transmission apparatuses 4 and the signal detection devices 7 of the ground units 20 are connected to a common controller 22. Therefore, the controller 22 is connected to the power transmission apparatuses 4 and the signal detection devices 7 of a plurality of ground units 20. Further, the controller 22 receives information from the plurality of signal detection devices 7 connected to the controller 22, and controls the plurality of power transmission apparatuses 4 connected to the controller 22.

In the present modification as well, the power transmission apparatuses 4 of the ground units 20 are controlled similarly to the above embodiment. Therefore, for example, when the signal detection device 7 of the second ground unit 20 from the upstream side does not receive a signal from the vehicle 3, the controller 22 controls the power transmission apparatus 4 of the second ground unit 20, based on the vehicle information contained in the signal received by the signal detection device 7 of the ground unit 20 positioned upstream most and the power transmission result information at the ground unit 20 positioned upstream most.

Further, in the above embodiments, the ground units 20 had signal detection devices 7. However, only the ground unit 20 positioned upstream most may have a detection device 7. In this case, the controllers 22 of any ground unit 20 in the second or following place from the upstream side control the power transmission apparatuses 4 of that ground unit 20, based on the vehicle information contained in the signal received by the signal detection device 7 of the ground unit 20 positioned upstream most and power transmission result information at the ground units 20 positioned at the upstream side from that ground unit 20.

Therefore, if expressed all together so that such a modification is also included, one signal detection device 7 of a ground power supply apparatus 2 is arranged at the upstream side from the upstream most power transmission apparatus 4 in the direction of advance of the vehicle 3 so as to be able to detect a signal including vehicle information, and the controller 22 controls power transmission from power transmission apparatuses 4 other than the first power transmission apparatus 4A positioned upstream most in the direction of advance of the vehicle 3, based on the signal detected by the first signal detection device 7A and the power transmission result information at the power transmission apparatus 4 positioned at the upstream side from that power transmission apparatus 4.

Above, preferred embodiments and a modification according to the present invention were explained, but the present invention is not limited to these embodiments. Various corrections and changes can be made within the language of the claims.

1. A ground power supply apparatus for transmitting power to a vehicle by noncontact, comprising:
a plurality of power transmission apparatuses for transmitting power to the vehicle;
at least one detection device for detecting a signal including information on the vehicle relating to power transfer, including vehicle identification information, emitted from the vehicle using narrow range wireless communication; and
a control device for controlling the power transmission apparatuses, wherein
the power transmission apparatuses are arranged in a road aligned in a direction of advance of the vehicle,
one first detection device among the detection devices is arranged so as to enable detection of the signal at an upstream side from the most upstream power transmission apparatus in the direction of advance of the vehicle, and
the control device controls transmission of power from power transmission apparatuses other than the first power transmission apparatus positioned the most upstream in the direction of advance of the vehicle, based on the signal detected by the first detection device and power transmission result information at the power transmission apparatus positioned at the upstream side from that power transmission apparatus.

2. The ground power supply apparatus according to claim 1, wherein
the ground power supply apparatus has a plurality of ground units respectively comprising the power transmission apparatus, the detection device, and the control device,
the control devices of the different ground units are connected to be able to communicate with each other, and
the power transmission apparatus of each ground unit is controlled by the control device of that ground unit.

3. The ground power supply apparatus according to claim 1, wherein
the ground power supply apparatus has a plurality of ground units respectively comprising the power transmission apparatus and the detection device, and
the control device is connected to the power transmission apparatuses and the detection devices of the plurality of ground units and controls the plurality of power transmission apparatuses connected to that control device.

4. The ground power supply apparatus according to claim 2, wherein the detection device of each ground unit is arranged so as to enable detection of the signal from the vehicle when the vehicle is positioned at an upstream side from the power transmission apparatuses of that ground unit in the direction of advance of the vehicle.

5. The ground power supply apparatus according to claim 2, wherein the control device for controlling a power transmission apparatus of the ground unit provided at a second place or following places from the upstream side in the direction of advance of the vehicle controls the power transmission apparatus of that ground unit, based on the information included in the signal detected by the detection device of that ground unit, regardless of the information contained in the signal detected by the first detection device and power transmission result information in the power transmission apparatus of the ground unit positioned at the upstream side from that ground unit, when the detection device of that ground unit detects the signal including the information.

6. The ground power supply apparatus according to claim 2, wherein the control device for controlling the power transmission apparatus of the ground unit provided at a third place or following places from the upstream side in the direction of advance of the vehicle controls the power transmission apparatus of that ground unit, based on the information included in a signal detected by the signal detection device of an intermediate ground unit downstream from a most upstream ground unit having the first detection device and upstream from that ground unit and power transmission result information in the detection device of the ground unit downstream from the intermediate ground unit and upstream from that ground unit, when the detection device of that ground unit does not detect a signal from the vehicle and the detection device of the intermediate ground unit detects a signal including the information.

7. The ground power supply apparatus according to claim 3, wherein the control device controlling the power transmission apparatus of each ground unit does not allow power transmission from the power transmission apparatus of that ground unit to the vehicle, when the detection device of that ground unit and the detection device of the ground unit arranged at an upstream side from that ground unit do not receive the information.
